(19) United States
(12) Patent Application Publication
(10) Pub. No.: US 2008/0073395 A1
(43) Pub. Date: Mar. 27, 2008

(54) Cycle portage apparatus and systems thereof having removable tire support

(75) Inventors: Michael K. Reeves, Woodinville, WA (US); Eric L. Rayl, Woodinville, WA (US); Gerald M. Stewart, Seattle, WA (US)

Correspondence Address: GRAYBEAL, JACKSON, HALEY LLP, 155 - 108TH AVENUE NE, SUITE 350, BELLEVUE, WA, 98004-5973, US

(73) Assignee: Sportworks Northwest, Inc., Woodinville, WA (US)

(21) Appl. No.: 11/904,233

(22) Filed: Sep. 25, 2007

Related U.S. Application Data
(60) Provisional application No. 60/847,189, filed on Sep. 25, 2006.

(51) Int. Cl. B60R 9/10

(52) U.S. Cl. 224/324

(57) ABSTRACT

Cycle portage apparatus and/or systems employing at least one removable, tire receiving means for retaining a cycle having at least two tires. One series of embodiments is directed to frames adapted to removably receive a tire receiving structure while another series of embodiments is directed to a specific type of such structure, namely, one or more tire trays, and frames optimized to receive them. The preferred applications for embodiments of the invention include transit vehicles having bumper mounted portage frames extending from such bumpers where the frames may be rotated from a stowed position to a deployed position in order to receive at least one cycle, usually a bicycle. Tire tray embodiments according to the invention are constructed from a material having greater resiliency than structural components of the frame.

### BACKGROUND OF THE INVENTION

In recent years, public transit has been required to accommodate persons with disabilities and has desired to accommodate persons that would otherwise not use public transportation, such as bicycle riders. In the former case, transit coaches have been adapted to provide lift assistance for users of wheel chairs or who are otherwise mobility impaired. In the later case, coaches have been outfitted with bicycle racks, usually in the front of the coach, whereby users can load and unload their bicycles when taking public transportation.

Since the inception of such bicycle racks, there have been various improvements in both the usability and durability aspects of the technology. Attention has been paid to the bicycle hold-down features of the racks and to the rack's ability to pivot from a deployed position to a stowed position. However, previous bicycle rack designs were generally of a welded steel or aluminum construction with the bicycle supporting elements (“receiving means”) integral to the rack structure. Potential causes of damage to these receiving means included collision with other vehicles or roadway obstacles, parking in the bus overnight storage area “bus barn” where high bus density was often required, and the bus wash, which is similar to a car wash but on a larger scale. In addition, bus drivers typically intentionally impacted the bus wash brush rollers with a significant force to separate them at the start of the wash process, which often caused rack damage. Repairs to damaged racks involved cutting, bending, welding and painting in many cases.

In addition to the foregoing, bicycle racks of the prior art generally offered only one or two fixed locations for stowage of a bicycle. While the location was selected to provide the greatest fitment to commonly used transit vehicles, it did not satisfactorily address every installation. Moreover, it was not possible to add an additional bicycle stowage location; interference with existing bicycles would result.

### SUMMARY OF THE INVENTION

The invention is generally directed to cycle portage apparatus and/or systems that employ at least one removable, tire receiving means for retaining a cycle having at least two tires. One series of embodiments is directed to frames adapted to removably receive a tire receiving means while another series of embodiments is directed to a specific type of such means, i.e., one or more tire trays, and frames optimized to receive them. The preferred applications for embodiments of the invention include transit vehicles having bumper mounted portage frames extending from such bumpers where the frames may be rotated from a stowed position to a deployed position in order to receive at least one cycle, usually a bicycle.

Tire tray embodiments according to the invention comprise at least one tire tray configured to receive at least one cycle tire, and are constructed from a material having greater resiliency than structural components of the frame. Such tray embodiments define a longitudinal direction, a lateral direction, lateral sides for retaining a tire and a wheel receiving side. The lateral sides and/or the wheel receiving side may be solid, foraminous, or otherwise constructed, taking into account design and application objectives, as well as material limitations. The tire tray embodiments may be mounted to the frame via a frame receiving side, which is preferably opposite the wheel receiving side, and preferably includes longitudinally oriented frame engaging members that removably encompass a portion of the frame. Alternatively, the tire tray may be mounted to the frame via mounting interfaces located about the periphery of the tray, e.g., a side wall. These peripheral mounting interfaces can engage an upper portion or surface of the frame, a lower portion or surface of the frame, and/or a side portion or surface of the frame, depending upon design considerations.

Each tray embodiment according to the invention may be configured to receive one or multiple tires of a cycle; preferred embodiments provide single trays configured to receive two tires. Furthermore, while the resiliency of the trays according to the invention is greater than that of the frame structural components, and thus is material non-specific, preferred embodiments are constructed from non-metallic materials such as fiber reinforced thermosetting (injection) plastics or thermoformed plastics, which provide the desired levels of performance.

The geometry of tray embodiments of the invention not only maximizes Z-axis deflection (load support) while retaining desired compliance in all other axis vectors, but also securely accommodates tires of various sizes. In particular, at least a portion of each tray includes a dual channel profile where more narrow tires fit within a first channel and wider tires fit within a second channel that “flanks” the first channel. Thus, narrow tires of a given diameter will rest “deeper” in the equipped tray than similar diameter wide tires in at least that portion of the tray having the dual channel feature.

As previously noted, preferred tray embodiments of the invention may utilize polymeric materials to provide the desired level of performance. In particular, the trays are characterized as resilient, and particularly so over the working range of the anticipated installation. Possessing such qualifications, preferred embodiments of the tire tray resist damage from small impacts that occur during use of the vehicle or system, minimizes damage to objects that impact the tray(s) (persons or property) or are impacted by the tray(s) (front mask of the vehicle). Preferred embodiments of the invention have a flexural modulus of between about 40 KSI and 120 KSI throughout the operation range of the installation, and additionally are not subject to brittle fracture at about −40° C. Material selection, such as thermosetting materials using reaction injection molding, ensure such properties for optimal performance while design geometries enhances load bearing as well as impact deflection properties. The trays need not be constructed from a homogenous material, but may represent hybrid structures both in overall composition, e.g., glass mat and resin, and/or discrete structure, e.g., steel spanning structure mounted to the frame with opposing wheel trays, one for each tire, constructed from a polymer.

The use of a non-metal (particularly non-steel) tire trays significantly lightens the overall system, thereby decreasing stress at the vehicle mounting interface, provides a corrosion resistant system when used in conjunction with stainless steel frame components and stainless steel fasteners, and in the case of polymer constructed trays, requires no “repair” if reasonably impacted. In many preferred embodiments, a single tire tray having two tire wells weigh approximately 2.5 Kg (5.6 lbs.).

Frame embodiments according to the invention may, but need not, use the above-described tray embodiments, but nevertheless comprise at least one removable tire receiving means, which interfaces with the frame in any of the modes described above with respect to the tray embodiments. The frame embodiments include a primary support structure comprising first and second spaced apart longitudinal members having distal and proximal ends, and which are joined by a first fixedly attached cross member where the cross member may be continuous or discontinuous with respect to the longitudinal members, and may comprise means for receiving a cycle tire such as possessing tire wells or (a) tray(s).

Mounting flanges may extend from the longitudinal members at the proximal ends thereof or from any cross member positioned adjacent to the proximal ends, and are adapted to engage with a target vehicle, such as a public transit vehicle having a complementary linkage. An assist spring may be used to impart an “upward” or stowed position bias to the frame, thus decreasing the degree of effort a user must exert in order to stow the frame, as is common in most applications. The frame may also comprise a latching assembly to retain the frame in a stowed position and/or a deployed position, as is also common in most applications.

An optional second cross member may be used, which may be effectively permanent or removable, and may also function as a means for receiving a cycle, either with or without the benefit of additional structure such as a tire tray. If the second cross member is not included, or functions as a means for receiving a cycle but is not removable, then a removable tray must be used if the configuration is to hold only three cycles. In other words, at least one of the tire receiving means must be intentionally removable from the frames of the invention.

The removable tire receiving means of the frame embodiments of the invention, as implied above, may constitute a structural cross member or not. Whether structural (in which case such means are preferably constructed from the same material as the frame elements, and with geometries that take frame integrity into consideration given the dual purpose of the structural member) or not, the mode of attachment to the frame may be via mounting interfaces located under the tire receiving means, and/or about the periphery of the tire receiving means to engage an upper portion or surface of the frame, a lower portion or surface of the frame, and/or a side portion or surface of the frame. Depending upon the application, such frames may be constructed to comprise two or more removable tire receiving means, each of which may or may not constitute a structural cross member. In addition, the tire receiving means may also include the dual channel feature referenced above with respect to tray embodiments of the invention.

Further frame embodiments of the invention provide means for establishing a greater number of tire receiving means than the number of transverse frame members, e.g., the first and second cross members. In these embodiments, a single cross member may be longitudinally offset over the lateral direction so that two tire receiving means can be accepted or integrated by or into a single cross member or other laterally extending member. It therefore becomes apparent that the same basic support frame used for two cycle portage applications can be modified through the simple addition or substitution (or adaptation) of a cross member and be transformed into a three cycle portage apparatus. Moreover, if the tire receiving means are removable from the supporting structure, the location of the tire receiving means may be selectable by the user within certain parameters, thus permitting the user to optimally configure the system for a particular use or fitment, e.g., location of headlights and/or turn signals of the equipped vehicle.

In addition to the foregoing, frame embodiments of the invention may comprises at least one wheel retention assembly for selectively retaining therein a cycle tire that is placed in the tire receiving means. The wheel retention assembly includes a wheel clamp arm, tire jaw (with or without variable tire width accommodation means such as dual contacting surfaces and/or dual channels) and an optional mounting interface. The wheel clamp arm is preferably rotationally mounted either directly or indirectly (via the mounting interface) to the frame, thus providing both flexibility in use by accommodating cycles having disparate wheel diameters as well as efficient stowage when not in use. In one series of embodiments, a mounting interface selectively engages the frame and further provides a pivotal connection location for the support arm. Through this arrangement, a robust linkage between the wheel clamp arm and the frame can be achieved, and in embodiments where the mounting interface engages with the tire receiving means, the mounting interface can also act as a tire chock.

In addition to the foregoing, the mounting interface can be constructed to receive or integrate with the tire receiving means, thereby providing a robust means for mounting at least a portion of a tire receiving means to the frame. Moreover, localized rigidity in an otherwise generally more compliant structure can be achieved, which is particularly beneficial at any frame engaging member portion of the tire receiving means. In such embodiments, the function of the mounting interface for the wheel clamp arm extends into performance considerations with respect to the tire receiving means, and can be designed as such. Of course, the skilled practitioner will appreciate that the mounting interface can be built into or integrated with the wheel receiving means as opposed to being a separate structured used in conjunction therewith, or similarly can be integrated with the frame, although having it as a separate component further increases componentization of the invention embodiments, which is considered advantageous over the prior art.

### BRIEF DESCRIPTION OF THE DRAWINGS

FIG. 1 is a perspective view of a three cycle rack;

FIG. 2 is a plan view of a two cycle rack;

FIG. 3 is a more plan view of the cycle rack of FIG. 1;

FIG. 4 is an exploded perspective view of a wheel retention assembly;

FIG. 5 is an elevation view of a bicycle engaged a distal tray of the cycle rack of FIG. 1;

FIG. 6 is an isolated partial cross section elevation view of the wheel retention assembly of FIG. 4, shown in a collapsed state;

FIG. 7 is shows the wheel retention assembly of FIG. 6 in an extended state, engaging with a bicycle wheel; and

FIG. 8 is an isolated perspective view of a bicycle engaged a tray of the cycle rack of FIG. 1.

### DESCRIPTION OF THE INVENTION EMBODIMENTS

The following discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention as defined by the appended claims. Thus, the present invention is not intended to be limited to the embodiments shown, but is to be accorded the widest scope consistent with the principles and features disclosed herein.

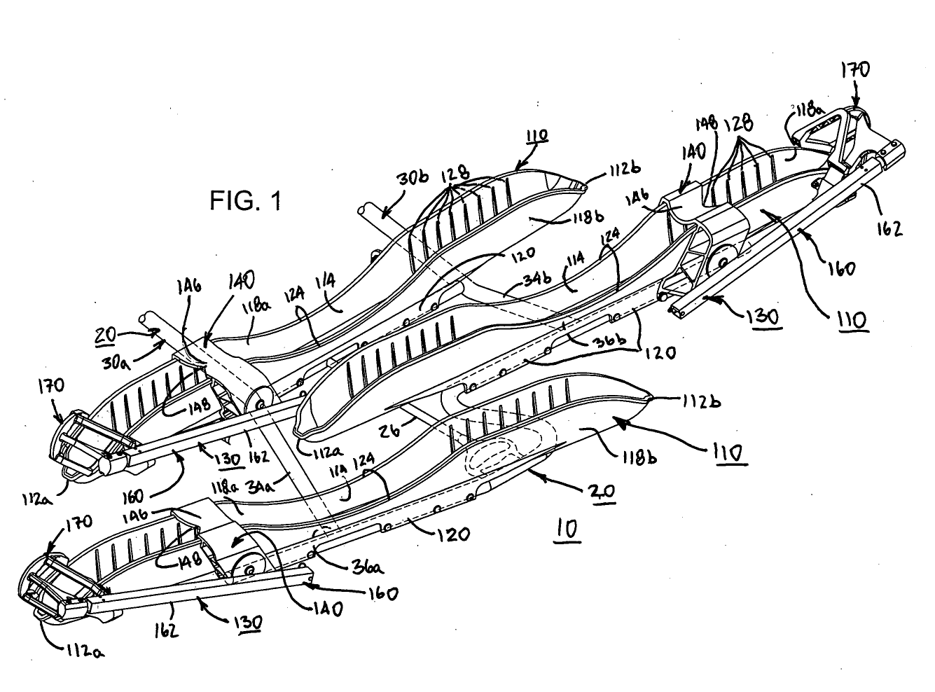

The following pages will identify the parts of the illustrated embodiments and in conjunction with the appended drawings, their locations. Like parts are given like numbers in the several drawings. Turning then to FIGS. 1-3, two bicycle carrier assembly 10′ and three bicycle carrier assembly 10 are shown. The illustrated carrier assemblies are intended to be mounted to a front bumper of a transit vehicle and be carried in an upright or vertical position during non-use, and deployed in a horizontal position during use. Each carrier assembly 10 and 10′ has means provided to interface with a receiver bracket associated with bumper of the transit vehicle, as will be detailed below.

Both carrier assemblies 10 and 10′ are preferable constructed from a durable material such as a metal (e.g., steel, steel alloys or aluminum) or a composite, given the intended environment of use. In these cases, the intended environment of use is both for supporting the intended loads and surviving the intended environments, as detailed previously. Thus, any material capable of meeting the use and longevity requirements of the deployment is considered suitable frame material.

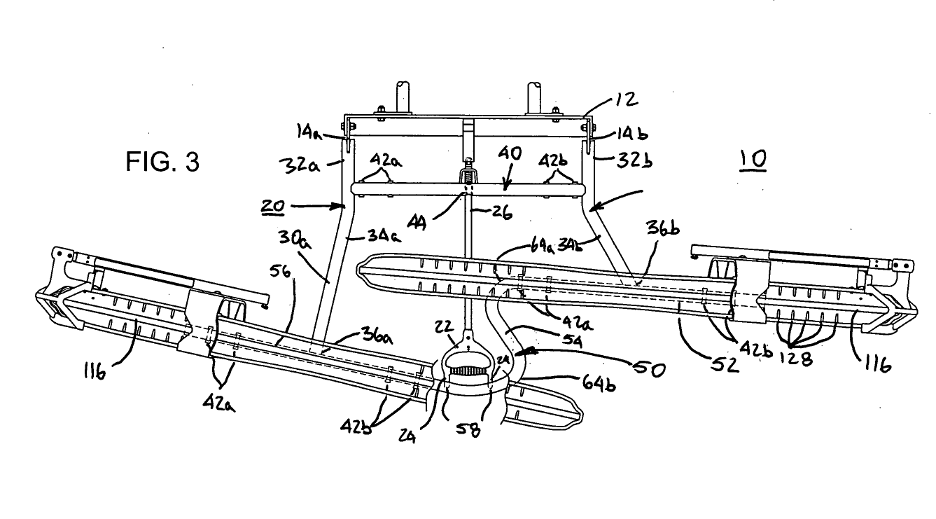

Each carrier assembly 10 and 10′ comprises three major elements, namely, frame 20 or 20′ depending upon configuration, wheel retention assembly 130, and trays 110. Referring first to the constituent elements of frame 20, each frame 20 comprises longitudinal member 30a and 30b, although only one such support member is needed. Each longitudinal member 30a and 30b has respective proximal end 32a and 32b, body portion 34a and 34b, and distal end 36a and 36b. Formed at or attached to proximal ends 32a and 32b are flanges 38a and 38b, which interface with receivers 14a and 14b of bumper mount 12 (see FIG. 3) and are retained therewith by fasteners 16.

Linking longitudinal members 30a and 30b is a cross member, which can be a structural element and/or a bicycle tray. In the case of frame 20, proximal cross member 40 serves this function in a structural sense, and provides bicycle tray mounting interfaces 42a and 42b. In addition, it defines release rod through hole 44 in which is located bushing 46 (preferably constructed from a high molecular weight plastic), which serves to guide and support release rod 26.

Release rod 26, in conjunction with release bias assembly 28, which is mounted on the proximal side of proximal cross member 40, functions to maintain the orientation of frame 20 relative to bumper mount 12 in either a stowed or deployed position by selectively retracting rod 26 using handle 22. Further information regarding this aspect of frame 20 can be found in U.S. Pat. Nos. 5,692,659 and 7,104,430, which are incorporated herein by reference.

In addition to proximal cross member 40, another cross member is used, namely distal cross member 50. As with proximal cross member 40, distal cross member 50 includes tray mounting interfaces as well as means for linking longitudinal members 30a and 30b. In this embodiment, distal cross member 50 functions to support two trays 110 through the use of an “S” geometry, which will now be described in more detail.

Particularly referencing FIG. 3, distal cross member 50 includes first segment 52, which is characterized as generally linear and laterally oriented, second segment 54, which is characterized as generally linear and longitudinally oriented, and third segment 56, which is also characterized as generally linear and laterally oriented. Transition segment 64a links segment 52 to segment 54 while transition segment 64b links segment 54 to segment 56. The resulting configuration enables a single structural cross member to function as a support member for two trays, namely tray mounting interface 62a and 62b as well as tray mounting interface 66a and 66b. Moreover, because the tray supporting structure only extends laterally as far as is needed to support a tray 110, the lateral profile of rigid material for frame 20 is significantly minimized as compared to three bicycle embodiments of the prior art. In addition to these functions and features, release handle guide pin holes 58 are formed in the proximal side of the cross member to receive release handle guide pins 24, which penetrate these holes upon retraction of handle 22.

In addition to the advantages identified above concerning the use of an “S” cross member, additional advantages include reduced materials and labor costs, advantageous tray orientation to reduce bicycle-to-bicycle interference with the distal and middle trays are occupied, reduced part count and improved aesthetics.

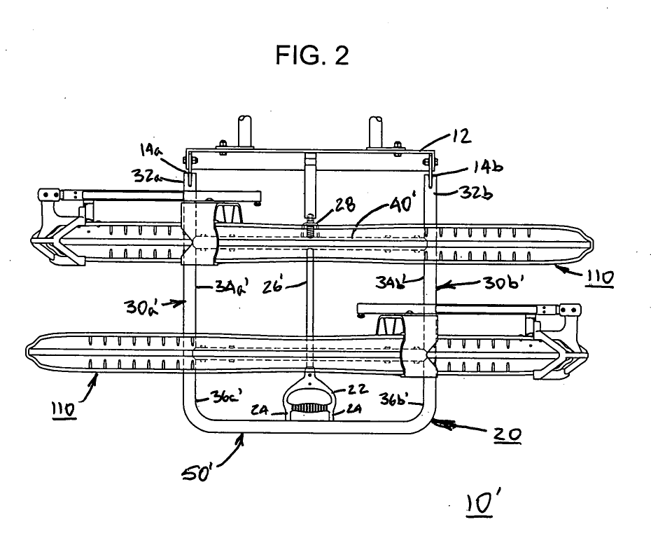

In addition to a three tray configuration, embodiments of the invention provide for a two tray embodiment, particularly shown in FIG. 2. In most relevant respects, frame 20′ is similar to frame 20, but with the following differences. First, conventional distal cross member 50′ replaces “S” cross member 50. Because cross member 50′ only supports a single tray 110, it comprises only a single tray mounting interface 62a/b′ pair, and is generally transversely mounted to longitudinal members 30a′ and 30b′. Consequently, body portions 34a′ and 34b′ as well as distal ends 36a′ and 36b′ are modified for obvious reasons.

Returning to FIGS. 1-3, the details and advantages of tray 110 will be described. As noted previously, each tray 110 in the illustrated embodiments is identical. Thus, only a single injection molding tool is needed for manufacturing a distal, middle or proximal tray. Additionally, each tray 110 is preferably symmetrical about the tray center so that any tray may be mounted in any direction or “handedness”. This approach again extols the virtues of a componentized approach to creating assemblies 10 and 10′.

Each tray 110 comprises ends 112a and 112b, separated by mid section 114. Tray 110 further includes wheel supporting surface 116 and side walls 118a and 118b. Opposed to supporting surface 116 is frame support interface portion 120, which contacts and partially surrounds a desired frame portion, and, in conjunction with mounting interfaces 122a and 122b, engage with any one of tray mounting interfaces 42a/b, 62a/b, 66a/b, or 62a′/b′. Tray 110 further comprises in the illustrated embodiments scalloped mid section 124, drip holes 126 to prevent unintended water retention that may affect a user returning assembly 10 to the stowed position after deployment in wet conditions, and vertical lands 128 to assist in securely retaining a tire placed there against.

The illustrated design advantageously provides support in the Z-axis (downward), i.e., it provides a suitable load bearing surface, but beneficially is relatively compliant in the Z+axis (upward) outboard of the frame-tray interface zones. Moreover, longitudinal as well as lateral forces also result in intended compliance compared to the Z-axis. In this respect, the illustrated embodiments exploit this feature of tray 110 by permitting up to 54% of each tray to extend beyond frame interface portion 120 (27% on each end 112a/b). Thus, when subjected to Z+, X± or Y± axis forces, tray 110 will beneficially “give” in a resilient mode as opposed to fail and then require replacement.

As described previously, tray 110 is constructed from a plastic material, and preferably from an injection molded thermosetting glass impregnated urethane. This material has been selected in view of its mechanical properties, which are considered desirable for this type of applications. Preferred embodiments of the invention have a flexural modulus of between about 40 KSI and 120 KSI throughout the operation range of the coach, and additionally not be subject to brittle fracture at about −40° C. Other materials and processes can be used, the desirability determined in part by the anticipated operation environment, performance criteria and cost.

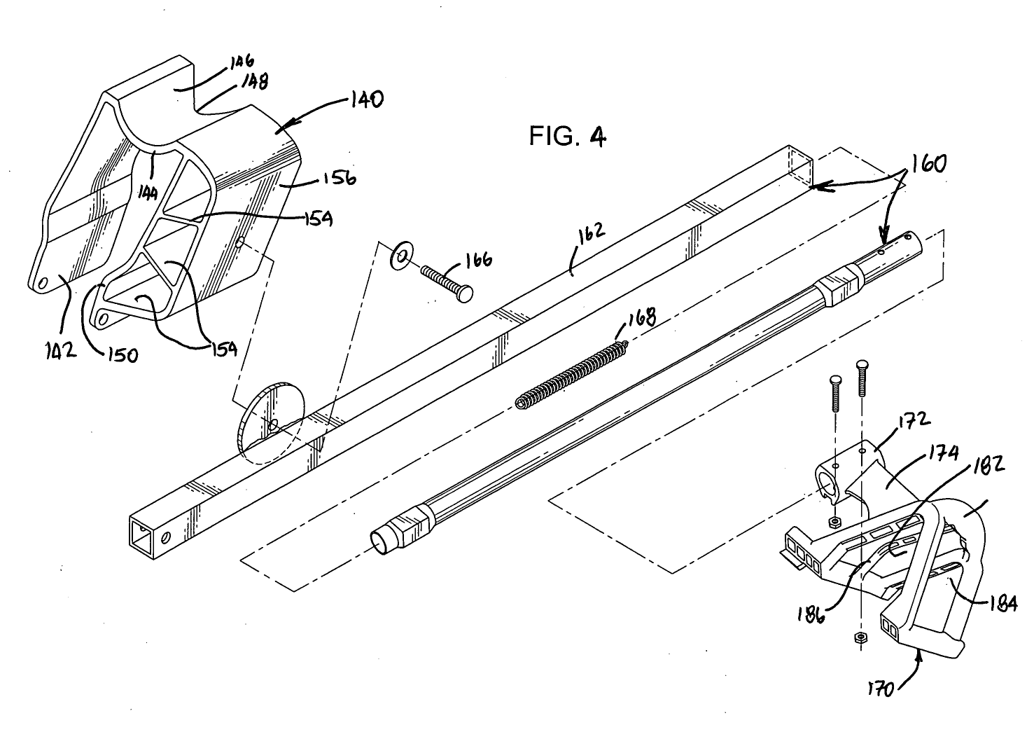

In order to retain a bicycle residing in tray 110, some form of retention means must be used. In furtherance of the objective to componentized assemblies 10 and 10′, identical means are chosen. Moreover, the same components of each means can be used regardless of orientation or “handedness.” Referring then to FIGS. 4-7, wheel retention assembly 130, comprising mounting interface or bracket 140 and biased wheel clamp arm 160 is shown. Mounting bracket 140 is preferably constructed from the same material as tray 110, in part due to its desirable mechanical properties and in part due to cost savings associated with economies achieved during production. Each mounting bracket 140 comprises leg 142, web 144, which includes concave surface 146 and tire recess 148, and which links leg 142 to leg 150. Mounting bracket 140 further comprises frame portion 152, which provides a suitable interface between bracket 140 and frame 20 or 20′, and stiffening elements 154. Finally, biased wheel clamp arm 160 interfaces with mounting bracket 140 at interface portion 156.

In embodiments such as those illustrated herein, biased wheel clamp arm 160 advantageously derives structural support from frame 20 and 20′, since trays 110 are intended to be flexible and/or non-structural. The skilled practitioner will of course appreciate that in embodiments wherein the tray functions as a cross member or other structural component, the biased wheel clamp arm can derive such support from the tray/cross member. Thus, the advantages of each component are exploited and undesirable interference between components reduced or eliminated.

As noted above, each wheel retention assembly 130 also comprises biased wheel clamp arm 160, which is pivotally linked to mounting bracket 140 via pivot 166 at interface portion 156. Wheel clamp arm 160 includes a telescoping arrangement comprising inner tube 162a surrounded by outer tube 162b. Bias assembly 164 links the two tubes and provides a retracting bias there to. In particular, spring 168 provides the linkage and bias. At the end of inner tube 162a opposite from spring 168's linkage therewith, tire jaw/handle 170 interfaces therewith via inner tube interface 172, and is connected thereto using chemical or mechanical fastening means. Tire jaw/handle 170 includes offset member 174, which provides a location for extending pawl 176. As will be described in more detail below, extending pawl 176 engages with progressive ratcheting surface 190 to retain wheel clamp arm 160 when in a stowed position.

A benefit of the disclosed design is that any wheel retention assembly 130 can be configured for left or right-handed use, i.e., mirror images. This arrangement permits any assembly 130 to be mounted on any tray 110 and in any orientation, such as shown between FIGS. 1 and 3.

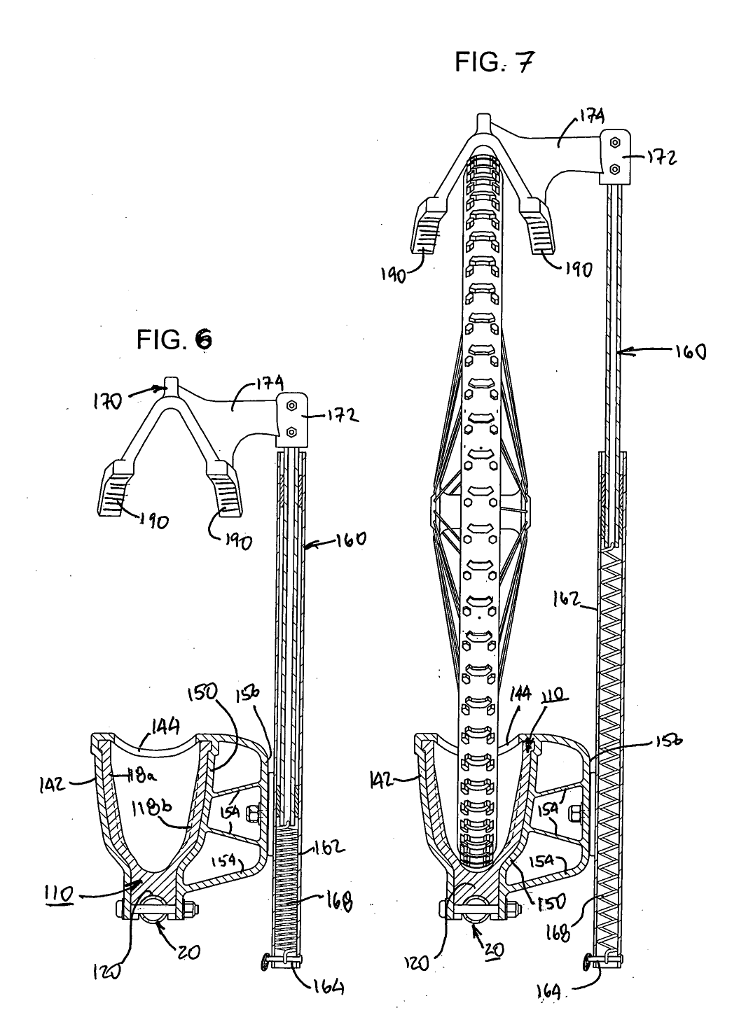

A feature of tire jaw/handle 170 is its extension from inner tube 162a. As bicycle tire diameters have increased, tire jaws of the prior art failed to have the reach necessary to engage these larger tires. Rather than re-engineering the wheel clamp tubes, a more desirable solution was to extend the tire jaw further there from, as is best shown in FIGS. 6 and 7. Another feature of tire jaw/handle 170 relates to the geometry and size of first and second jaw openings 182 and 184 of variable wheel width jaws 180. Here, two different angles or profiles can be used, one optimized for narrow width road bicycle tires and the other optimized for wide width off road bicycle tires. By taking into account the arc of rotation and tangential contact of variable wheel width jaws 180, an appropriate angle between tire jaw/handle 170 and inner/outer tubes 162a and 162b can be established that will permit a use to rotate biased wheel clamp arm 160 to accommodate either type of tire.

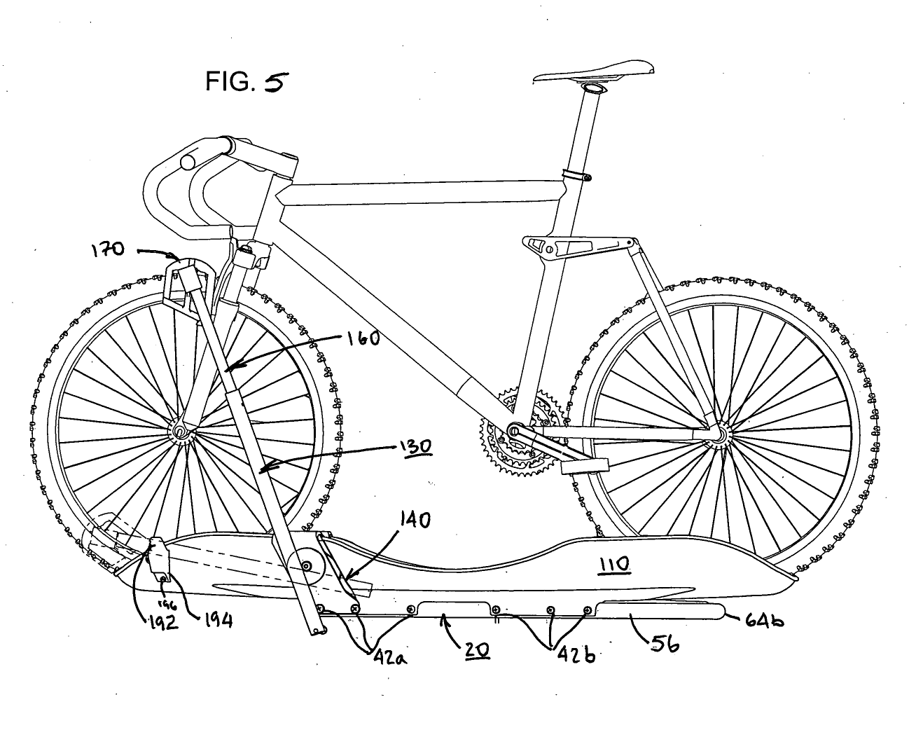

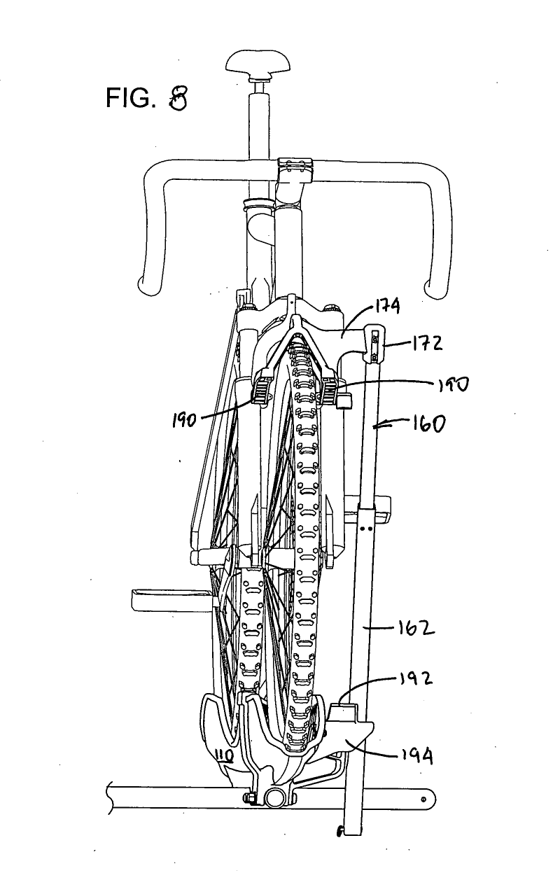

As mentioned previously, means should be provided to prevent the unintended deployment of wheel retention assembly 130 when not in use. While a torsion spring arrangement can be used, a simpler and more reliable means is to provide a latching arrangement between wheel retention assembly 130 and tray 110 or frame 20/20′. In the embodiments illustrated in FIGS. 5 and 8, progressive ratcheting surface 190 is mounted to tray 110 via tray mounting interface 194 and fasteners 196, and provides a reactive surface for extending pawl 176 when wheel retention assembly 130 is in a stowed position. Ratcheting surface 190 includes inclined buttress teeth, which progressively engage with pawl 176. An inclined surface and progressive engagement is used to ensure an adequate engagement in view of the differences in thermal expansion between tray 110, which is preferably constructed entirely from composite material, and wheel retention assembly, which is generally constructed from a metal such as aluminum.

What is claimed:

1. A transversely mounted cycle tray for use with a longitudinally extending cycle portage frame for motorized vehicles having a longitudinal axis comprising:
a generally “V” or “U” shaped resilient, non-metallic channel.

2. The cycle tray of claim 1 wherein the channel is constructed from a polymer having a flexural modulus of between about 40 and 120 KSI.

3. The cycle tray of claim 1 wherein the channel is constructed from a polymer having a flexural modulus of less than 150,000 KSI at −22° F., and of greater than 50,000 KSI at 158° F.

4. The cycle tray of claim 1 wherein the cycle tray has greater resiliency bending around a vertical axis, and in bending upward around a horizontal perpendicular to the tray major axis than in bending downward around a horizontal axis perpendicular to the tray horizontal axis.

5. The cycle tray of claim 1 wherein the cycle tray comprises mounting locations at least 10% inboard from each end of the tray such that when mounted to the frame, at least 20% of the cycle tray extends beyond lateral boundaries of the frame.

6. The cycle tray of claim 1 wherein the channel has a mass less than 2.6 kg.

7. The cycle tray of claim 1 wherein the channel is not a structural member of the frame.

8. The cycle tray of claim 1 wherein the cycle tray comprises two physically separate portions, each portion for receiving a single cycle tire.

9. The cycle tray of claim 1 wherein the channel is formed from a thermosetting polymer.

10. A longitudinally extending cycle portage system for motorized vehicles comprising:
a frame having first and second spaced apart longitudinal members, each having respective first and second ends separated by a body portion, a cross member linking the first leg to the second leg, and a vehicle mounting interface at or proximate to a second end of the frame; and
a user replaceable cycle tray removably engagable with the frame.

11. The cycle portage system of claim 10 wherein the user replaceable cycle tray engages both frame legs.

12. The cycle portage system of claim 10 wherein the user replaceable cycle tray engages the cross member.

13. The cycle portage system of claim 10 wherein the cross member includes means for receiving a cycle.

14. The cycle portage system of claim 10 wherein the single vehicle mounting interface comprises a pair of spaced apart longitudinally extending tabs.

15. The cycle portage system of claim 10 wherein the cross member is curvilinear.

16. The cycle portage system of claim 10 wherein the user replaceable cycle tray comprises two physically separate portions, each portion for receiving a single cycle tire.

17. The cycle portage system of claim 10 further comprising a cycle retention member rotationally linked to the frame for engaging a portion of a cycle.

18. The cycle portage system of claim 17 but wherein the cycle retention member is rotationally linked to the tray for engaging a portion of a cycle.

19. The cycle tray of claim 1 wherein the portage frame comprises first and second spaced apart longitudinal members, each having respective first and second ends separated by a body portion, a cross member linking the first leg to the second leg, and a vehicle mounting interface at or proximate to a second end of the frame, where the tray engages both frame legs.

20. The cycle tray of claim 19 but wherein the tray engages the cross member.
